(19) United States
(12) Patent Application Publication
(10) Pub. No.: US 2006/0115553 A1
(43) Pub. Date: Jun. 1, 2006

(54) Nutrition bar or other food product and process of making

(75) Inventors: Akhilesh Gautam, Arlington, TN (US); Matthew Patrick, Annapolis, MD (US); Michael Lynn Dagerath, Bartlett, TN (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Slim-Fast Foods Company, division of Conopco, Inc.

(21) Appl. No.: 11/000,644

(22) Filed: Dec. 1, 2004

(51) Int. Cl. A23L 1/30

(52) U.S. Cl. 426/72

(57) ABSTRACT

A nutrition bar or other food which incorporates pro-oxidants and/or polyunsaturated fatty acids or their sources in encapsulated form, especially as microcapsules. The pro-oxidants may be metal salts such as copper, manganese, iron and/or zinc salts. Sources of omega-3 fatty acids include fish oil. Processes for preparing the polyunsaturated fatty acid capsules are also disclosed. The polyunsaturated fatty acid capsules/microcapsules are prepared by forming an emulsion of the unsaturated fatty acid with a carrier, spray drying the emulsion to form a powder and encapsulating powder, especially with a fluid bed. The invention is especially useful for encapsulating polyunsaturated fatty acids, or oil sources thereof, most preferably omega-3 and omega-6 fatty acids, such as arachidonic acid, docosahexaenoic acid (DHA), eicosapentaenoic acid (EPA), lineoleic acid, linolenic acid (alpha linolenic acid), and gamma-linolenic acids, fish oil, and oil sources of C18:2 and C18:3 fatty acids such as canola oil, soybean oil or blends thereof.

### BACKGROUND OF THE INVENTION

Increasingly, a focus of modern preventive medicine is weight reduction. Excessive weight is frequently cited in reports of a recent increase in cases of type 2 diabetes. Moreover, obesity is often mentioned in discussions of other modern diseases, such as heart disease.

An increasingly popular form for ingestion of nutrients for those seeking to lose weight is the nutrition bar. The nutrition bar provides a convenient vehicle for replacing a meal or for supplementing meals as a snack.

Snacks can serve several goals such as satisfying hunger between meals or providing a source of energy. While consumers express a preference for snacks and other foods which are more healthful and which can assist them to achieve their weight loss goals, they show little inclination to sacrifice the organoleptic properties of their favorite foods or snacks.

When nutrition bars are intended as replacement for a meal, it is particularly important that they contain a range of nutrients. Most preferably, the nutrient mix in the nutrition bar resembles that of the balanced meal which it is intended to replace. However, even where nutrition bars are not intended to replace a meal, a balanced mix of macronutrients and of micronutrients such as vitamins and minerals, may be of benefit.

Consumers have embraced other forms of foods intended to assist in weight reduction, as well. These include soups and powdered beverages which may, too, benefit from inclusion of appropriate macro- and micronutrients.

Much public attention has been paid in the last few years to a variety of food ingredients which reportedly have beneficial properties for the health. Among the most celebrated of these are the omega-6 and especially the omega-3, fatty acids. One or more of these acids, and/or their sources, have been recommended for numerous conditions, such as high blood pressure, rheumatoid arthritis, undesirable cholesterol levels, mental acuity problems, infections, elevated blood lipids, and even cancer.

While it may be desirable to add omega-3 and/or omega-6 fatty acids and/or their sources to ingestable formulations, several characteristics of these nutrients make their inclusion in good tasting food products a challenge. For example, since these are polyunsaturated fatty acids, they have a tendency to oxidize.

Fatty acids other than fish oils also have been reported to have salutary properties, yet are susceptible to undesirable oxidation in the product. Most notable among these are the other polyunsaturated fatty acids (PUFA's).

Copper is a mineral, the health benefits of which are receiving increasing attention. Benefits concerning anemia, and decreased lipid oxidation in the body have been noted. Unfortunately, in many product formulations, copper tends to promote oxidation. And, special challenges are presented when omega-3, omega-6 or other polyunsaturated fatty acid (PUFA)-containing oils are present together with pro-oxidants such as copper since the presence of copper exacerbates the already substantial potential for oxidation inherent in the use of these.

Since consumers are reluctant to accept foods with poor organoleptic properties, notwithstanding any anticipated health benefits, it is highly desirable to prepare the foods in such a way that the likelihood of oxidation of any omega-3 and/or omega-6 fatty acids, any other polyunsaturated fatty acids and, indeed, any food components susceptible to oxidation in the presence of pro-oxidants like copper, is minimized.

Various references disclose food supplements which can be in the form of bars. These include WO 01/56402, Portman U.S. Pat. No. 6,051,236 (alpha lipoic acid which may be encapsulated in liposomes), Gilles et al. U.S. Pat. No. 6,248,375 (nutritional bar which may include fish oil), Anon, “Nutraceuticals-International,” 2000, Vol 5, p 25 (from abstract number 548502), Swartz, M L, “Milk proteins and hydrolysates in nutritional foods,” “Food Ingredients Europe: Conference Proceedings, London, October 1994, published in “Maarssen: Processs Press Europe,” 1994, 73-81 (from Abstract number 373368), Swartz, M L, “Food-Marketing-&-Technology”, vol 9, 4, 6, 9-10, 12, 20 (from abstract number 1995-08-P0036), Kaufman WO 01/33976, Keating et al. EP 768 043 (may include fish oil) and DeMichele et al. U.S. Pat. No. 6,444,700 (products which are useful for stress which may include fish oils; products in form of bars are discussed).

Animal feed products which include fish oil have been proposed, for example, in U.S. Pat. Nos. 5,120,565 and 5,540,932.

Van Den Berg et al. U.S. Pat. No. 6,048,557 is directed to a process for preparing a polyunsaturated fatty acid (PUFA)-containing composition wherein a PUFA-containing lipid is adsorbed or coated onto a solid carrier, such as a powder. In Example 6, the PUFA is combined with a whey protein carrier using a fluidized bed granulator.

Hijiya et al. U.S. Pat. Nos. 4,775,749 and 4,777,162 are directed to a cyclodextrin inclusion complex of eicosapentaenoic acid (EPA) and to a food product containing the compound. The undesirable odor of EPA is said to be masked by including it in the compound. The compound may be dried, pulverized and prepared into a granule or tablet.

EP 424 578 is directed to a dry solid composition containing lipids, such as fish oil, protected in sodium caseinate. The lipid contains from 10 to 50% by weight free fatty acid. The composition can be in free-flowing, particulate form. The composition is made by homogenizing acidic lipid and an aqueous caseinate solution together, and then drying as by fluid bed drying, spray drying or drum drying.

EP 425 213 is directed to a dry free flowing particulate composition containing from 70-95 wt % lipid, which is prepared by drying a liquid emulsion of lipid in an aqueous solution of sodium caseinate and dextrin having a dextrose equivalent of less than 10. It is said that the dry composition can protect unsaturated oils against oxidative deterioration. The liquid emulsion of lipid in an aqueous solution containing caseinate and dextrin can be dried by fluid bed drying, spray drying, or drum (film) drying. An especially preferred process is said to involve spray drying followed by agglomeration, e.g., using a fluidized bed. In an especially preferred embodiment, the lipid is fish oil.

EP 385 081 is directed to a dried fat emulsion. It describes prior processes in which the emulsions are prepared by emulsifying fat or oil which is then dried, such as by spray drying. The fat molecules are encapsulated by a film-forming material. In the '081 invention, a second portion of film forming material is added prior to or after drying, such as during “instantizing” of the dried emulsion concentrate. The second portion of film forming material is said to be effective in improving resistance of the dried fat emulsion products to oxidative deterioration and development of rancidity. The amount of film forming material in the aqueous dispersion should be sufficient to provide a continuous film encapsulating the fat globules in the emulsion. It is said that the dried emulsion product of the invention may be used in production of dry food systems.

Rubin U.S. Pat. No. 5,013,569 discloses an infant formula including DHA and EPA. It mentions various microencapsulation techniques for the DHA, EPA and for immunoglobulins.

GB Patent Application 2 240 702 is directed to a process for preparing a fatty fodder additive for domestic animals which increases the content of omega-3-fatty acids within the meats when the fodder additive is fed to the animal. The additives may be prepared by selecting a fat such as fish oil, selecting a carrier such as casein, homogenizing the oil and the carrier and drying using a spray drier or fluid bed. The powdered fat is then coated with an enteric coating material using a fluid bed coater. While claim 13 talks of a process for preparing “food” additives, in the context of the entire document, this may mean “fodder.”

Derwent abstract number 011973261 for FR 2 758 055 discloses a fluid powder comprising microcapsules consisting of fish oil rich in polyunsaturated fatty acids which are fixed onto a solid matrix which is a colloid associated with one or more carbohydrates. The fluid powder is obtained by emulsification and drying at low temperatures in a spray tower.

Schroeder et al. U.S. Pat. No. 4,913,921 is directed to food products wherein non-hydrogenated fish oil is stabilized by fructose. The invention is said to find particular suitability for use in connection with fish oils rich in omega-3 fatty acids. Various food products, such as dressings, are disclosed.

Skelback et al. U.S. Pat. No. 6,444,242 is directed to a microencapsulated oil or fat product wherein at least one oil or fat is dispersed in a matrix material, the oil or fat containing at least 10% by weight of highly unsaturated fatty acids, preferably omega-3 and omega-6 fatty acids. The microencapsulated oil or fat product is obtained by mixing the oil and an aqueous solution of caseinate, and optionally a carbohydrate-containing matrix, homogenizing, and drying the resulting emulsion to obtain free flowing microparticles. The emulsion may be spray dried, preferably in a modified spray dried process at a hot air temperature of 70° C. Fluid bed drying or drum drying may also be used. Infant formula, health functional food, and dietetic foods are among the applications mentioned.

Skelback et al. mention two published Japanese patent applications, No. 85-49097 and 90-305898 disclosing powdered fish oils. One mentions encapsulation and the other spray drying. WO 88/02221 is directed to a granulate comprising an oil-powder mixture which may contain marine oil having gamma linolenic acid (GLA), EPA and/or DHA. The oil/powder mixture is made by heating the oil, dissolving a defatted carrier in the oil, mixing, homogenizing, and drying using a conventional spray drier. The powder formed in the spray drier can be lowered to room temperature by passing a fluid bed dryer or similar device.

The Wright Group of Crowley, La. offers the following edible wax-encapsulated minerals (metals or salts) under the name SuperCoat™:

WE 101266 (Iron), WE 101265 (zinc). WE 101270 (copper) and WE 101267 (manganese).

The California Dairy Research Foundation website, www.cdrf.org/newsletter/dbfall00/dbeat3.htm accessed on Apr. 17, 2004, indicated in its “Frequently Asked Questions About Edible Films and Coatings” portion of the Dairy Dispatch section that various edible waxes (e.g., beeswax, carnauba wax, candellia wax) are used to coat candies, pharmaceuticals and fresh fruits and vegetables. The waxes are said to provide a moisture and oxygen barrier and a glossy surface. Coatings on frozen foods to prevent oxidation and to prevent moisture, aroma or color migration are also mentioned. It is also said that research is underway at UC Davis involving combination of polysaccharides and proteins with various hydrophobic lipid materials (e.g., edible waxes, fatty acids, triglycerides including milkfat fractions) to achieve good moisture barrier coatings and films with acceptable mechanical integrity.

WO 03/079818 discloses an alertness bar which may include sources of omega 3 fatty acids. Essential minerals are mentioned as well.

Sears U.S. Pat. No. 6,140,304 (Eicotech Corp.) discloses a bar having a marine oil containing EPA and copper. It is not clear in what form copper is incorporated into the bar.

A ZONEPerfect® Nutrition Bar, Chocolate Mint flavor, available for sale in the United States at least as of Jul. 28, 2004, discloses that it contains 3 mg of “OMEGA 3” and lists fish oil among its ingredients. The package is marked “BEST BY April 05.”

Although there have been many previous efforts to formulate foods with omega-3 and/or omega-6 and other unsaturated fatty acids, there is a need for a good way of incorporating copper and other pro-oxidant minerals (Mn, Fe, Zn etc.) into foods containing unsaturated fatty acids.

### SUMMARY OF THE INVENTION

In accordance with a first aspect, the present invention is directed to nutrition products, such as nutrition bars and soups, sweet powders and other food products, especially those with a water activity (aw) of 0.75 or less, especially 0.65 or less, as well as to processes for preparing such products, wherein the products incorporate omega-3 and/or omega-6 and/or other polyunsaturated fatty acids in combination with pro-oxidant minerals such as copper compounds.

The formulations according to the first aspect of the invention can be expected to have a very good shelf life, yet include polyunsaturated fatty acids which generally have a tendency to oxidize, together with normally pro-oxidant compounds in encapsulated form, especially copper. Previously it would have been expected that where pro-oxidant copper and omega-3 or other unsaturated fatty acids are combined in the same formulation, the fatty acids would oxidize and the shelf life of the food product would be unacceptable.

In accordance with a preferred aspect of the invention, the pro-oxidant is encapsulated with carnauba wax and/or other waxes.

In another aspect, the present invention is directed to a process for incorporating polyunsaturated fatty acids or a source thereof, especially omega-3 and/or omega-6 fatty acids, into copper- or other prooxidant-containing foods for human consumption, especially nutrition bars, soups and sweet powders, by utilizing encapsulated pro-oxidant. A blend of canola and soybean oils at a weight ratio of 65:35 to 35:65, especially about 50:50, is preferred. The canola/soybean oil blend desirably includes one or more antioxidants such as BHT, TBHQ or ascorbic acid plus rosemary extract. Preferably the polyunsaturated fatty acids are encapsulated with carnauba wax.

In accordance with another aspect of the invention, the omega-3 or omega-6 fatty acids are themselves encapsulated. Especially preferred is to use omega-3, omega-6 or other polyunsaturated fatty acids encapsulated by spray drying the fatty acid onto a carrier such as corn-, milk-, soy- and other proteins, or starch or other polysaccharides, and then encapsulating the spray dried fatty acid with wax or other encapsulating agent. Preferably the encapsulated polyunsaturated fatty acids are used in a nutrition bar or other food product, particularly one which includes the encapsulated pro-oxidants.

In the first step of the process, polyunsaturated fatty acids, and most especially omega-3 and/or omega 6 acids, are combined with a carrier and spray dried to form a powder. Typically an emulsion will be formed with the carrier and the unsaturated fatty acids prior to spray drying. Examples of suitable carriers include modified food starches, maltodextrins, proteins such as soy protein and caseinate, sugars and mixtures thereof. Then, the spray dried powder is encapsulated, for example in a fluid bed dryer or a rotating disc, with one or more encapsulating agents. Among the contemplated encapsulating agents are hard fats (solid at 72° F.), edible waxes, especially higher melting point waxes, cellulose and protein, e.g., milk proteins such as caseinates, and zein.

The unsaturated fatty acids can be present as free fatty acids, but more typically will be present esterified to glycerol as mono-, di- or most preferably tri-acylglycerols. Unless otherwise required by context, references to any unsaturated fatty acids herein includes also reference to sources thereof such as triacylglycerols.

The encapsulated oils, may then be incorporated into a food for human consumption. Suitable examples include nutrition bars, ready-to-drink beverages, soups, and spreads, and other foods, preferably those with aw of 0.75 or less, preferably 0.65 or less, especially 0.6 or less, such as breakfast cereals, baked goods, etc. It is anticipated that the spray dried and encapsulated oils will be less susceptible to oxidation and the off tastes which accompany oxidation and which are also inherently present in the oils and sources thereof. Most preferably, the food includes both the encapsulated pro-oxidant(s) such as copper and the encapsulated polyunsaturated fatty acid(s).

A still further aspect of the invention relates to the discovery that food products, such as food bars and soups, can be stabilized with a particular blend of oils which is a source of omega-3 and omega-6 fatty acids. The blend is a combination of canola and soybean oils, preferably with one or more antioxidants. The canola and soybean oils are preferably present in the blend at a ratio by weight canola to soybean of from 35:65 to 65:35, especially about 50:50. The blend is particularly useful for preparing food bars having sources of omega-3 and omega-6 fatty acids and excellent shelf life. The invention is directed to the blends per se, the food bars and other products including the blends, and processes of making the food products using the blends.

For a more complete understanding of the above and other features and advantages of the invention, reference should be made to the following description of the preferred embodiments

### DETAILED DESCRIPTION OF THE INVENTION

The present invention may be used to protect any polyunsaturated fatty acid in the food, and most especially to protect omega-3 and/or omega-6 fatty acids. Among the polyunsaturated fatty acids for which the invention may be useful are included arachidonic acid, docosahexaenoic acid (DHA), eicosapentaenoic acid (EPA), lineoleic acid, linolenic acid (alpha linolenic acid) and gamma-linolenic acid.

Among sources for the unsaturated acids which are encapsulated in accordance with the process of the invention, and/or which are protected by the encapsulated pro-oxidant according to the invention, may be included vegetable oils, marine oils such as fish oils and fish liver oils and algae. Possible vegetable oil sources include olive oil, soybean oil, canola oil, high oleic sunflower seed oil, high oleic safflower oil, safflower oil, sunflower seed oil, flaxseed (linseed) oil, corn oil, cottonseed oil, peanut oil, evening primrose oil, borage oil, and blackcurrant oil.

In accordance with one aspect of the invention, encapsulated sources of copper or other pro-oxidants are preferably used herein. Encapsulated pro-oxidants are preferably present at a level of from 15 to 100% RDA. Preferred are encapsulated copper salts such as microencapsulated cupric gluconate available from the Wright Group of Crowley, La. Another pro-oxidant copper salt which could benefit from encapsulation according to the present invention is copper sulfate. Encapsulated pro-oxidant salt products available from Wright include the following available under the name SuperCoat™:

We 101266 (Iron), We 101265 (zinc). We 101270 (copper) and We 101267 (manganese). Encapsulated pro-oxidant salts are preferably present at a level of from 0.3 to 0.85% by wt.

In accordance with one aspect of the invention, the pro-oxidants are coated with an edible wax, such as beeswax, carnauba wax, candellia wax, paraffin wax or mixtures thereof. Preferably the wax has a melting point greater than 65° C. Alternatively, the pro-oxidant can be coated with another coating material which provides resistance to food processing conditions/variables such as temperature, shear, moisture and oxygen levels, such as stearic acid, hard fats, edible waxes, cellulose and protein. Examples of hard fats include hydrogenated soy bean or cotton seed oils. Preferably, the pro-oxidants are completely coated by the wax or other encapsulating agent.

The food of the invention may be any of several foods which could be supplemented with and/or contain pro-oxidant minerals and polyunsaturated fatty acids. Preferably the food is a nutrition bar or is a food having a water activity of 0.75 or less, preferably 0.65 or less, especially 0.6 or less.

The food of the invention may include protein sources. Preferred sources of protein include sources of whey protein such as whey protein isolate and whey protein concentrate, sources of rice protein such as rice flour and rice protein concentrate, and sources of pea protein. Soy protein may also be used. The protein may be present in the food in discrete nuggets, in other forms, or both in nuggets and external to nuggets.

Additional protein sources include one or more of dairy protein source, such as whole milk, skim milk, buttermilk, condensed milk, evaporated milk, milk solids non-fat, etc. The dairy source may contribute dairy fat and/or non-fat milk solids such as lactose and milk proteins, e.g. the whey proteins and caseins. Especially preferred, to minimize the caloric impact, is the addition of protein as such rather than as one component of a food ingredient such as whole milk. Preferred in this respect are protein concentrates such as one or more of whey protein concentrate as mentioned above, milk protein concentrate, caseinates such as sodium and/or calcium caseinate, isolated soy protein and soy protein concentrate. Total protein levels within the foods of the invention, particularly when the food takes the form of a nutrition bar, are preferably within the range of 3 wt % to 50 wt %, such as from 3 wt % to 30 wt %, especially from 3 wt % to 20%.

When protein nuggets are employed, they typically include greater than 50 wt % of protein selected from the group consisting of milk protein, rice protein and pea protein and mixtures thereof, especially between 51 wt % and 99 wt %, more preferably between 52 wt % and 95 wt %, most preferably 55 wt % or above. Other ingredients which may be present in the nuggets would include one or more of other proteins, such as those listed above, include lipids, especially triglyceride fats, and carbohydrates, especially starches. Particularly where the nuggets are made using the moderated temperature extrusion process described below, it is advisable that the remaining ingredients be no more sensitive to heat degradation (e.g., have the same or lower degradation point) than the selected non-soy protein.

The food of the invention may include various oils or fats including the unsaturated fatty acids protected from pro-oxidants herein. In addition to those mentioned above, such oils and fats include other vegetable fat, such as for example, cocoa butter, illipe, shea, palm, palm kernal, sal, soybean, safflower, cottonseed, coconut, rapeseed, canola, corn and sunflower oils, or mixtures thereof. A blend of oils (e.g., canola, soybean, or high oleic oils) may be used, especially containing either synthetic antioxidants such as BHT, TBHQ or natural antioxidants such as mixed tocopherols, ascorbic acid and rosemary extract or a blend of the above. When the source is for linoleic and linolenic acids (C18:2 and C18:3), straight oil or blends of oil such as canola plus soybean with an appropriate antioxidant system can be used. However, animal fats such as butter fat may also be used if consistent with the desired nutritional profile of the product.

An especially preferred blend of oils for use in the bars, pastas, powdered beverages, soups and other foods of the invention is a blend of canola and soybean oils at a weight ratio canola to soybean of from 35:65 to 65:35, especially about 50:50. The blend may be used in the bars and other foods of the invention at levels of from 2 to 25 wt %, especially from 5 to 20 wt %, most especially from 8 to 12wt %. The blend provides a good, stable source of omega-3 and omega-6 fatty acids. For instance, levels of 0.15 to 0.2 g/serving of omega-3 and 1 to 2 g per serving of omega-6 are readily provided by the canola/soybean blend in food having an excellent shelf life as long as 12 or even 14 months. The canola/soybean blend preferably includes antioxidants, in particular BHT or TBHQ or a combination of ascorbic acid and rosemary extract, preferably at levels of 50 to 3000 ppm.

In general, where encapsulated oils containing PUFA moieties are used in accordance with the invention, added antioxidants such as tocopherols, ascorbic acid and/or rosemary extract may be omitted; that is, the oils may be free of added antioxidants. Where non-encapsulated oils containing PUFA moieties are used, it is preferred that added antioxidants such as tocopherols, ascorbic acid and/or rosemary extract be present in the oil.

Polyunsaturated fats, particularly those containing omega-3 and omega-6 fatty acids, are preferably incorporated as encapsulates made in accordance with the process of the invention. Or, they can be incorporated into the product as oils, or in other forms such as alternative capsules or microcapsules, for example in the microcapsules of EP 648 076, the disclosure of which is incorporated by reference herein. The term “capsules” herein shall encompass encapsulates formed in accordance with the process of the invention and other encapsulating processes as well as shells into which a product has been placed. “Microcapsules” herein refers to capsules of very small size such as those of EP 648 076.

In the case of a nutrition bar, preferably the amount of fat is not more than 45 wt %, especially not more than 35 wt %, preferably from 0.5 to 10 wt %, still preferably from 0.5 to 5 wt %.

Carbohydrates can be used in the food of the invention at levels of from 0 to 90%, especially from 1% to 49%. In addition to sweeteners, the fibers and the carbohydrate bulking agents mentioned below, examples of suitable carbohydrates include starches such as are contained in rice flour, flour, peanut flour, tapioca flour, tapioca starch, and whole wheat flour and mixtures thereof. Where the food takes the form of a nutrition bar, levels of carbohydrates in the bar as a whole will typically comprise from 5 wt % to 90 wt %, especially from 20% to 65 wt %.

If it is desired to include a bulking agent in the food, within or external to the nuggets or capsules/microcapsules, a preferred bulking agent is inert polydextrose. Polydextrose may be obtained under the brand name Litesse. Other conventional bulking agents which may be used alone or in combination include maltodextrin, sugar alcohols, corn syrup solids, sugars or starches. Total bulking agent levels in the foods, e.g., nutritional bars, of the invention, will preferably be from about 0% to 20 wt %, preferably 5% to 16%.

Flavorings are preferably added to the food or nutrition bar in amounts that will impart a mild, pleasant flavor. The flavoring may be in nuggets or the capsules/microcapsules or external to the nuggets and capsules/microcapsules in the bar or other food, provided that processing is not adversely affected. The flavoring may be any of the commercial flavors employed in nutrition bars or other foods, such as varying types of cocoa, pure vanilla or artificial flavor, such as vanillin, ethyl vanillin, chocolate, malt, mint, yogurt powder, extracts, spices, such as cinnamon, nutmeg and ginger, mixtures thereof, and the like. It will be appreciated that many flavor variations may be obtained by combinations of the basic flavors. The nutrition bars or other foods are flavored to taste. Suitable flavorants may also include seasoning, such as salt (sodium chloride) or potassium chloride, and imitation fruit or chocolate flavors either singly or in any suitable combination. Flavorings which mask off-tastes from vitamins and/or minerals and other ingredients are preferably included in the products of the invention, in the capsules/microcapsules, in protein nuggets and/or elsewhere in the product. Preferably, flavorants are present at from 0.25 to 3 wt % of the food, excluding salt or potassium chloride, which is generally present at from 0 to 1%, especially 0.1 to 0.5%.

The capsules, any nuggets and the bar or other food may include colorants, if desired, such as caramel colorant. Colorants are generally in the food at from 0 to 2 wt %, especially from 0.1 to 1%.

If desired, the food, especially the nuggets, may include processing aids such as calcium chloride.

As indicated above, the unsaturated oils will typically be emulsified with a carrier prior to spray drying. Typical emulsifying agents may be phospholipids and proteins or esters of long chain fatty acids and a polyhydric alcohol. Lecithin is an example. Fatty acid esters of glycerol, polyglycerol esters of fatty acids, sorbitan esters of fatty acids and polyoxyethylene and polyoxypropylene esters of fatty acids may be used but organoleptic properties, of course, must be considered. Mono- and di-glycerides are preferred. Emulsifiers may be used in the emulsions used to spray dry the unsaturated fatty acids in amounts of about 0.03% to 0.3%, preferably 0.05% to 0.1%. The same emulsifiers may also be present in the nutrition bar or other food and/or protein nuggets, again at levels overall of about 0.03% to 0.3%, preferably 0.05% to 0.1%. Emulsifiers may be used in combination, as appropriate. Any nuggets may also include emulsifiers.

Typically the emulsion will be formed in a homogenizer such as a high pressure homogenizer from Invensys APV of Tonawanda, N.Y. The emulsion will typically comprise from 5 wt % to 25 wt o of carrier and 35 to 15 wt % of the unsaturated fatty acid. The emulsion typically will have about 40% solids and the balance water.

Among fiber sources which may be included in the foods of the invention are fructose oligosaccharides (fos) such as inulin, guar gum, gum arabic, gum acacia, oat fiber, cellulose, whole grains, and mixtures thereof. The compositions preferably contain at least 2 grams of fiber per 56 g serving, especially at least 5 grams of fiber per serving. Preferably, fiber sources are present in the product at greater than 0.5 wt. % and do not exceed 6 wt. %, especially 5 wt. %. As indicated above, additional bulking agents such as maltodextrin, sugar alcohols, corn syrup solids, sugars, starches and mixtures thereof may also be used. Total bulking agent levels in the products of the invention, including fibers and other bulking agents, but excluding sweeteners will preferably be from about 0% to 20%, especially from 1 to 15 wt %. The fiber and the bulking agent may be present in the food as a whole, e.g., the nutrition bar, and/or in capsules, nuggets, etc. provided that processing is not impaired.

Carrageenan may be included in the bars or other food of the invention, internal or external to the capsules and nuggets, eg, as a thickening and/or stabilizing agent (0 to 2 wt % on product, especially 0.2 to 1%). Cellulose gel and pectin are other thickeners which may be used alone or in combination, e.g., at 0 to 10 wt %, especially from 0.5 to 2 wt %.

Typically, if the food is a nutrition bar, or in any of a number product forms which are generally sweet, the food will be naturally sweetened. The sweetener may be included in the capsules/microcapsules or in any nuggets or elsewhere in the bar or food provided that it does not interfere with the processing of the capsule or nugget. Natural sources of sweetness include sucrose (liquid or solids), glucose, fructose, and corn syrup (liquid or solids), including high fructose corn syrup, corn syrup, maltitol corn syrup, high maltose corn syrup and mixtures thereof. Other sweeteners include lactose, maltose, glycerine, brown sugar and galactose and mixtures thereof. Polyol sweeteners other than sugars include the sugar alcohols such as maltitol, xylitol and erythritol. Levels of sweeteners and sugar sources preferably result in sugar and/or other polyol solids levels of up to 20 wt %, especially from 10 to 17 wt % of a nutrition bar.

If it is desired to use artificial sweeteners, these may likewise be present in the microcapsule and/or nugget and/or within the bar or other food external to the nugget, provided that it does not interfere with processing. Any of the artificial sweeteners well known in the art may be used, such as aspartame, saccharine, Alitame® (obtainable from Pfizer), acesulfame K (obtainable from Hoechst), cyclamates, neotame, sucralose, mixtures thereof and the like. The artificial sweeteners are used in varying amounts of about 0.005% to 1 wt % on the bar, preferably 0.007% to 0.73% depending on the sweetener, for example. Aspartame may be used at a level of 0.05% to 0.15%, preferably at a level of 0.07% to 0.11%. Acesulfame K is preferred at a level of 0.09% to 0.15%.

Calcium may be present in the nutrition bars or other foods at from 0 to 100% of RDA, preferably from 10 to 30% RDA, especially about 25% RDA. The calcium source is preferably dicalcium phosphate. For example, wt. % levels of dicalcium phosphate may range from 0.5 to 1.5%. In a preferred embodiment, the product is fortified with one or more vitamins and/or minerals and/or fiber sources, in addition to the calcium source. These may include any or all of the following:

Ascorbic acid (Vitamin C), Tocopheryl Acetate (Vitamin E), Biotin (Vitamin H), Vitamin A Palmitate, Niacinamide (Vitamin B3), Potassium Iodide, d-Calcium Pantothenate (Vitamin B5), Cyanocobalamin (Vitamin B12), Riboflavin (Vitamin B2), Thiamine Mononitrate (Vitamin B1), Molybdenum, Chromium, Selenium, Calcium Carbonate, Calcium Lactate, Manganese (e.g., as Manganese Sulfate), Magnesium (e.g., as magnesium phosphate), Iron (e.g., as Ferric Orthophosphate) and Zinc (as Zinc Oxide). The vitamins and minerals are preferably present at from 5 to 100% RDA, especially 5 to 50% RDA, most especially from about 15% RDA. The vitamins and/or minerals may be included within, or external to, the nuggets, provided that processing and human absorption are not impaired. Minerals which tend to be pro-oxidants, such as iron, may be included in the encapsulated form according to the present invention.

RDA as referred to herein is the Recommended Dietary Allowances 10^{th} ed., 1989, published by the National Academy of Science, National Academy Press, Washington, D.C.

Ingredients which, if present, will generally be found within a bar but external to the capsules or any nuggets include, but are not limited to, rolled oats, chocolate or compound chips or other chocolate or compound pieces, cookie and/or cookie dough pieces, such as oatmeal cookie pieces, brownie pieces, fruit pieces, such as dried cranberry, apple, etc., fruit jelly, vegetable pieces such as rice, honey and acidulants such as malic and citric acids, leavening agents such as sodium bicarbonate and peanut butter.

The foods of the invention may be made by known methods. The capsules are added to the foods at a convenient time in the processing, provided that the capsules are not exposed to temperatures which cause degradation of their ingredients. Likewise, if protein-containing nuggets are present, the processor must be sensitive to any conditions which could cause degradation of the nugget.

Extruded nutritional bars may be made by cooking a syrup containing liquid (at ambient temperature) ingredients and then mixing with dry ingredients. The mixture is then extruded onto a conveyor belt and cut with a cutter. Any nuggets, e.g., protein nuggets, are included among the dry ingredients. The capsules/microcapsules and any nuggets should only be added to the syrup when the syrup is at a temperature below that at which any of the capsules/microcapsule or nugget components degrade. Syrup ingredients may include components such as corn syrup, glycerine (0-20 wt % on total product, especially 0.5 to 10 wt %), lecithin and soybean oil or other liquid oils. In addition to the capsules and any nuggets, other dry components include grains, flours (e.g., rice or peanut), maltodextrin and milk powders.

Nutritional bars in the form of granola bars may be made by cooking the syrup, adding the dry ingredients, blending the syrup and dry ingredients in a blender, feeding the blended mix through rollers and cutting with a cutter.

The bars of the invention may be coated, eg with milk chocolate or yogurt flavored coating. Chocolates with little or no milk or milk products may be considered so as to maximize the presence of chocolate antioxidants and, if and to the extent desired, to try to avoid reported neutralization of antioxidants in the chocolate by milk or its components.

Typically, excluding moisture lost during processing, the uncoated bars of the invention will be made from 30-50 wt % syrup, especially 35-45%, and 50-70 wt % dry ingredients, especially 55-65 wt %. Generally, coated bars according to the invention will be made from 30-50 wt % syrup, especially 35-45 wt %, 40-50 wt % dry ingredients, especially 40-45% and 0-30 wt % coating (e.g, chocolate or compound coating), especially 5-25 wt %, particularly 10-20 wt % coating.

Nuggets may contain greater than 50 wt %, especially greater than 60%, more preferably greater than 70 or 80% of selected non-soy proteins selected from the group consisting of milk protein, rice protein and pea protein.

It can be expected that the benefits of the invention will be realized in various types of foods, including various types of nutrition bars including, without limitation, snack bars and meal replacement bars. One example would be granola bars. Other applicable foods include soups and sweet powders which may be used to sweeten, flavor and fortify beverages such as milk.

Soups according to the invention are prepared by dry mixing the ingredients, as is known in the art. All seasoning is added to a ribbon blender (powder mixer). Mixing takes between 12 and 15 minutes depending upon the number of ingredients and size of the batch in the mixer. The mix is placed into a large tote that is taken to the packaging line.

In the case of powdered beverages, the product will typically be made using the following process. The ingredients are scaled to the quantity dictated in the formulation. The scaled ingredients are placed in a sifter placed over a 20 mesh standard screening unit. The ingredients are then bumped though the standard screen. The screened ingredients are emptied into a container, the lid is sealed and then the container is shaken vigorously for at least two minutes. The contents of the container are emptied into a 20 mesh standard screen and then stored in an air tight container. Beverages are typically prepared by scaling out the appropriate serving size of powder, scaling out 8 oz. of refrigerated skim milk, pouring milk into a blender vessel, turning the blender to a low setting and adding powder to the agitating skim milk, covering the blender vessel with an appropriate closure, increasing the speed to mid-high power, agitating at mid-high power for 20-30 seconds and then stopping agitation. The beverage is typically served and consumed shortly after preparation.

### EXAMPLE 1 (PROPHETIC)

### Encapsulation of a Polyunsaturated Fatty Acid

Into 1 kg of water are mixed 100 g milk protein, 50 g modified food starch, 50 g flow agent, and 200 g oil. The mixture is emulsified using a high pressure homogenizer. The emulsion is then spray dried under a nitrogen blanket in a Niro lab spray drier at a dryer temperature of 400° F. The control outlet temperature is 210° F. The powder thus made is introduced to a lab GLATT fluid bed. 100 g of the powder is fluidized and sprayed with carnauba wax coating at 30 g of carnauba wax and 10 g of paraffin at 212° F. under a nitrogen blanket. Other high coating compounds which can be used, alone or in combination, are beeswax and stearic acid.

### EXAMPLE 2 (PROPHETIC)

The “center” of a coated bar is formed from the following components:

| Component | Wt % of Center |
|---|---|
| Protein | 25 |
| Sugar | 8 |
| Rice cereal | 16 |
| Soy protein | 6 |
| Vitamin/min- | 4 |
| eral mix (including | |
| microencapsulated | |
| cupric gluconate | |
| ex Wright Group) | |
| Sodium chloride | 0.5 |
| Corn syrup | 28.5 |
| Molasses | 4 |
| Peanut butter | 4 |
| Encapsulated DHA/PUFA | 4 |
| (made by procedure | |
| of Example 1) | |

The liquid components are mixed, after which the dry ingredients are added and mixed until the product is substantially homogeneous. The encapsulated PUFA/DHA is added with the dry components. The mixture is then fed into a die and extruded at room temperature and atmospheric pressure. Upon extrusion, the bar is cut into individual serving sizes which are then coated with a chocolate confectioner's compound coating. The bar is packaged and kept at 85° F. for 12 weeks, after which it is opened and eaten. No off taste is detected. Each week of successful storage at 85° F. is believed to equate to one month of successful storage at ambient temperature.

### EXAMPLE 3 (PROPHETIC)

Cream of Tomato Soup

| | Product |
|---|---|
| Ingredient Name | % |
| Whey Protein Concentrate | 25 |
| Tomato Power | 16-17 |
| Non fat dry milk | 14 |
| Instant Starch | 12 |
| Gum arabic | 8-9 |
| Sugar | 2-3 |
| Flavor Enhancer | 3-4 |
| Flavoring | 1-2 |
| Oil | 1-2 |
| Coloring | 1-2 |
| Agglomerated Calcium Caseinate | 1. |
| Disodium Phosphate | 1. |
| Onion Powder | 0.5 |
| Seasoning/spice | 1 |
| Garlic Powder | 0.2-0.3 |
| Gum, guar | 0.15-2 |
| Croutons | 4. |
| Vitamin/min- | 4 |
| eral mix (including | 100. |
| microencapsulated | |
| cupric gluconate | |
| ex Wright Group) | |

### EXAMPLE 4 (PROPHETIC)

An alfredo sauce is made by mixing together the following ingredients:

| Ingredient Name | Ingredient % |
|---|---|
| Starch | 13.6 |
| Cream Cheese Tang | 9.6 |
| Milk Pro. Conc. | 12.7 |
| Gum Acacia | 8.5 |
| Vitamin Premix | 7 |
| Ca caseinate | 5.9 |
| Grated Parmesan, | 5.7 |
| Uncolored cheese | 4.5 |
| Salt | 4.4 |
| Solka Floc, FC 300 | 3.4 |
| Romano Cheese | 2.8 |
| Cream flavor | 2.8 |
| Drawn butter flavor | 2.1 |
| Butter Buds 8X | 1.4 |
| Dipotassium Phosphate | 1.4 |
| Sugar | 1.1 |
| TiO2, | 0.85 |
| MSG, | 0.7 |
| Lactic acid powder | 0.7 |
| Garlic powder | 0.6 |
| Xanthan gum | 0.28 |
| Black pepper | 0.2 |
| Ground Nutmeg | 0.1 |
| Parsley, Whole | 0.1 |
| Citric Acid, Anhydrous | 0.08 |
| OIL (Soybean + Canola, BHT) | 10 |
| | 100.51 |

The vitamin premix contains encapsulated copper. Despite the presence of appreciable amounts of triglycerides containing omega-3 and omega-6 fatty acids, the product enjoys an excellent shelf life.

### EXAMPLE 5 (PROPHETIC)

A vanilla flavored beverage powder is made by mixing together the following ingredients:

| Ingredient Name | Ingredient % |
|---|---|
| Maltodextrin | 13.20% |
| Milk Protein Concentrate | 7.33% |
| Fiber | 7.33% |
| Carageenan | 0.83% |
| Premix, encapsulated Pro-oxidant | 4.70% |
| ACE-K | 0.15% |
| Aspartame | 0.15% |
| Avicel | 6.33% |
| Flavor | 2.50% |
| Xanthan Gum | 1.20% |
| Soybean + Canola oil (50:50) + A.A + R.E | 10.50% |
| Sugar | 39.00% |
| Soy Fiber | 5.10% |
| Lecithin | 0.52% |
| Salt | 0.60% |
| Guar gum | 0.50% |
| | 99.93% |

The product, which has encapsulated prooxidant minerals in the premix and which includes ascorbic acid and rosemary extract in the soybean/canola blend, is found to be organoleptically stable for 12 to 14 months.

Example 5 is repeated except that prooxidant minerals in the premix are not encapsulated and the soybean/canola oil blend lacks any added antioxidants. The shelf life of the product is reduced to 4-6 months.

It will be appreciated that when fatty acids are mentioned herein, generally these will present in the form of glycerides such as mono-, di- and triglycerides. Therefore, “fatty acids” encompasses glycerides containing them.

Unless stated otherwise or required by context, the terms “fat”0 and “oil” are used interchangeably herein. Unless otherwise stated or required by context, percentages are by weight.

The word “comprising” is used herein as “including, but not limited to” the specified ingredients. The words “including” and “having” are used synonymously.

It should be understood of course that the specific forms of the invention herein illustrated and described are intended to be representative only, as certain changes may be made therein without departing from the clear teaching of the disclosure. Accordingly, reference should be made to the appended claims in determining the full scope.

What is claimed is:

1. A process for making a food ingredient comprising, encapsulating unsaturated fatty acid or source thereof by forming an emulsion of the unsaturated fatty acid with a carrier, spray drying the emulsion to form a powder, and encapsulating said powder with an encapsulating agent.

2. The process according to claim 1 wherein said powder is encapsulated using a fluid bed or a rotating disc.

3. The process according to claim 1 wherein said unsaturated fatty acid is selected from the group consisting of arachidonic acid, docosahexaenoic acid (DHA), eicosapentaenoic acid (EPA), lineoleic acid, linolenic acid (alpha linolenic acid) and gamma-linolenic acid.

4. The process according to claim 3 wherein the source which is encapsulated is a fish oil.

5. A process for making a food product for humans comprising, encapsulating unsaturated fatty acid or source thereof by forming an emulsion of the unsaturated fatty acid with a carrier, spray drying the emulsion to form a powder, and encapsulating said powder with an encapsulating agent, and incorporating the encapsulated powder into a food for human consumption.

6. The process according to claim 5 wherein said food for human consumption is a nutrition bar.

7. The process according to claim 5 wherein said encapsulated powder is incorporated into the nutrition bar by adding the encapsulated powder to a syrup, the syrup is mixed with the powder and any other dry ingredients to form a dough, and extruding the dough.

8. The process according to claim 5 wherein said unsaturated fatty acid is selected from the group consisting of arachidonic acid, docosahexaenoic acid (DHA), eicosapentaenoic acid (EPA), lineoleic acid, linolenic acid (alpha linolenic acid) and gamma-linolenic acid.

9. The process according to claim 5 wherein the source which is encapsulated is a fish oil.

10. A food product made according to the process of claim 5.

11. The process according to claim 1 wherein the unsaturated fatty acid source which is encapsulated is a blend of canola oil and soybean oil.

12. The process according to claim 11 wherein the blend is at a weight ratio of canola oil to soybean oil of from 65:35 to 35:65.

13. The process according to claim 12 wherein the blend is used at a canola oil to soybean oil ratio of about 50:50.

14. The process according to claim 5 wherein the unsaturated fatty acid source which is encapsulated is a blend of canola oil and soybean oil.

15. The process according to claim 14 wherein the blend is at a weight ratio of canola oil to soybean oil of from 65:35 to 35:65.

16. The process according to claim 15 wherein the blend is used at a canola oil to soybean oil ratio of about 50:50.

17. An oil blend comprising canola and soybean oils at a weight ratio canola to soybean of from 35:65 to 65:35.

18. The oil blend according to claim 17 wherein the canola and soybean oils are present at a weight ratio canola to soybean of from 42:58 to 58:42.

19. The oil blend according to claim 18 wherein the weight ratio of canola to soybean oil is about 50:50.

20. The oil blend according to claim 17 further comprising an antioxidant which is one or more of BHT, TBHQ or a combination of ascorbic acid and rosemary extract.

21. A food product comprising an oil blend comprising canola and soybean oils at a weight ratio canola to soybean of from 35:65 to 65:35, the blend being present in the food product at a level of from 8 to 12 wt %.

22. The food product according to claim 21 which is a nutrition bar.

23. The food product according to claim 21 which is a soup.

24. The food product according to claim 21 wherein the blend of canola oil and soybean oil constitutes at least 98 wt % of the unsaturated fatty acid sources in the food product.
